(19) United States
(12) Patent Application Publication
(10) Pub. No.: US 2015/0266714 A1
(43) Pub. Date: Sep. 24, 2015

(54) WATER DISPENSER

(71) Applicant: KABUSHIKI KAISHA COSMO LIFE, Kakogawa-shi, Hyogo (JP)

(72) Inventor: Yoshinori Orita, Hyogo (JP)

(73) Assignee: Kabushiki Kaisha Cosmo Life, Hyogo (JP)

(21) Appl. No.: 14/435,477

(22) PCT Filed: Sep. 25, 2013
(86) PCT No.: PCT/JP2013/075835

§ 371 Date: Apr. 14, 2015

(30) Foreign Application Priority Data
Oct. 22, 2012 (JP) 2012-232772

(51) Int. Cl. B67D 3/00

(52) U.S. Cl. CPC B67D 3/0032; B67D 3/0038; B67D 3/0061; B67D 3/0083

(57) ABSTRACT

A water dispenser includes a water supply line having a pierced rod to which a raw water container having a plug is connected. The plug has a valve body formed with a claw portion which is hooked to a head of the pierced rod when the raw water container is connected to the water supply line. A through hole is formed in the head of the pierced rod at its portion closer to the distal end of the head than is its portion which contacts and pushes the claw portion, whereby atmospheric air in the space defined by a peripheral wall portion of the valve body is released into the pierced rod when the head is pushed into the space defined by the peripheral wall portion.

### TECHNICAL FIELD

The present invention relates to a water dispenser which is capable of discharging water supplied from a replaceable raw water container and stored in a temporary water storage tank, as drinking water.

### BACKGROUND ART

Such water dispensers are configured to discharge temperature-adjusted water stored in a temporary water storage tank through a water discharge line into e.g. a user's cup when a lever or a cock is operated by the user. A raw water container is located at a higher level or a lower level than the temporary water storage tank. Such water dispensers also include a casing in which are provided, besides the temporary water storage tank and the water discharge line, a container holder on which a raw water container is configured to be placed, and a water supply line through which raw water in the raw water container is fed into the temporary water storage tank (as disclosed in the below-identified Patent documents 1 and 2).

A conventional raw water container includes a plug comprising a plug body fixed to the container body, and a valve body for closing a valve hole formed in the plug body. The casing of the water dispenser is provided with a pierced rod for pushing the valve body closing the valve hole of the plug body into the raw water container. The pierced rod is formed with a raw water intake port through which raw water is introduced into the water supply line. The valve body includes a peripheral wall portion which can be press-fitted in the inner periphery of the valve hole, and a claw portion protruding from the peripheral wall portion over the entire circumference thereof. When a new raw water container is connected to the water supply line of the water dispenser, the head of the pierced rod pushes the claw portion over the entire circumference thereof, thus elastically deforming the claw portion in such a manner that the claw portion is pushed away from the head. When the head moves past the claw portion, the claw portion is hooked to the head over the entire circumference thereof, due to elastic recovery of the claw portion. When the valve body is continuously pushed by the pierced rod thereafter, the pierced rod is brought into close contact with the inner periphery of the valve hole, while pushing the valve body out of the valve hole, thereby separating the valve body from the plug body, until the raw water intake port moves into the raw water container. When the pierced rod is pulled out of the plug body, the peripheral wall portion of the valve body is fitted into the inner periphery of the valve hole, while the pierced rod is pulled out of the valve hole, until the valve body gets caught on the plug body. When the pierced rod is further pulled out of the plug body, the valve body is separated from the pierced rod. Thus, when the pierced rod is pulled out of the plug body, the valve hole is spontaneously closed by the valve body, so that it is possible to automatically prevent leakage of water remaining in the raw water container simply by raising the container.

### PRIOR ART DOCUMENTS

### Patent Documents

Patent document 1: JP Patent Publication 2010-228807A

Patent document 2: JP Patent 4802299B

### SUMMARY OF THE INVENTION

### Object of the Invention

When the head of the pierced rod pushes the claw portion of the valve body, the head is brought into close contact with the claw portion over the entire circumference of the claw portion, thus trapping atmospheric air in the space defined by the peripheral wall portion of the valve body. Thus, the head is pushed into the space defined by the peripheral wall portion while compressing air trapped therein, just like a piston. The trapped air thus makes advancement of the head difficult. This increases the possibility of the valve body separating from the plug body with the head not advanced until the claw portion is hooked to the head, due e.g. to dimensional errors of the raw water container.

An object of the present invention is to make it easier to hook the claw portion of the valve body to the head of the pierced rod when a new raw water container is connected to the water supply line of the water dispenser.

### Means for Achieving the Object

In order to achieve this object, the present invention provides a water dispenser comprising a casing, a temporary water storage tank provided in the casing, a container holder provided in the casing and on which a replaceable raw water container can be placed, a water supply line provided in the casing and through which raw water can be supplied from the raw water container into the temporary water storage tank, and a pierced rod provided in the casing and formed with a raw water intake port through which raw water can be fed into the raw water supply line, wherein the raw water container comprises a container body and a plug, the plug comprising a plug body fixed to the container body and formed with a valve hole, and a valve body capable of closing the valve hole, wherein the valve body includes a peripheral wall portion configured to be press-fitted into the inner periphery of the valve hole, and a claw portion protruding from the peripheral wall portion over the entire circumference of the peripheral wall portion, wherein the pierced rod has a head, wherein the water dispenser is configured: such that when the head is pushed into the plug body, the head pushes the claw portion of the valve body over the entire circumference of the claw portion until the claw portion gets caught on the head over the entire circumference of the claw portion, and thereafter, the pierced rod is brought into close contact with the inner periphery of the valve hole while pushing the valve body out of the valve hole until the valve body is separated from the plug body; and such that when the pierced rod is pulled out of the plug body, the peripheral wall portion is fitted into the inner periphery of the valve hole while the pierced rod is pulled out of the valve hole until the valve body gets caught on the plug body, and thereafter, the valve body is separated from the pierced rod, and wherein a through hole is formed in a portion of the head closer to the distal end of the head than is the portion of the head configured to contact and push the claw portion such that atmospheric air in the space defined by the peripheral wall portion is released into the pierced rod through the through hole.

### Advantages of the Invention

With the arrangement of the present invention, while the head is being pushed into the space defined by the peripheral wall portion, it is possible to release atmospheric air in the above space into the pierced rod through the above-described through hole, namely, the through hole formed in a portion of the head closer to the distal end of the head than is the portion of the head configured to contact and push the claw portion. This prevents the atmospheric air in the above space from being compressed by the head, which in turn makes it easier for the head to advance in the space defined by the peripheral wall. As a result, it is possible to achieve the object of the present invention, namely, the object of making it easier to hook the claw portion of the valve body to the head of the pierced rod when a new raw water container is connected to the water supply line of the water dispenser.

### BRIEF DESCRIPTION OF THE DRAWINGS

FIG. 1(a) is a partial sectional view of an embodiment of the present invention, showing the moment when a pierced rod pushes a valve body; and FIG. 1(b) is a partial sectional view of the embodiment, showing how the pierced rod is further pushed into the valve body from the state of FIG. 1(a).

FIG. 2 schematically shows an entire water dispenser embodying the present invention.

FIG. 3 is a side view of the embodiment, showing how a raw water container is placed in position.

FIG. 4 is plan view of the embodiment, showing how the raw water container is placed on a container holder.

FIG. 5 is a partial sectional view of the embodiment, showing the pierced rod and the surrounding area when the raw water container is placed on the container holder.

FIG. 6 is a partial sectional view of the embodiment, showing the pierced rod and the surrounding area while the raw water container is being moved toward the position of FIG. 5.

### BEST MODE FOR EMBODYING THE INVENTION

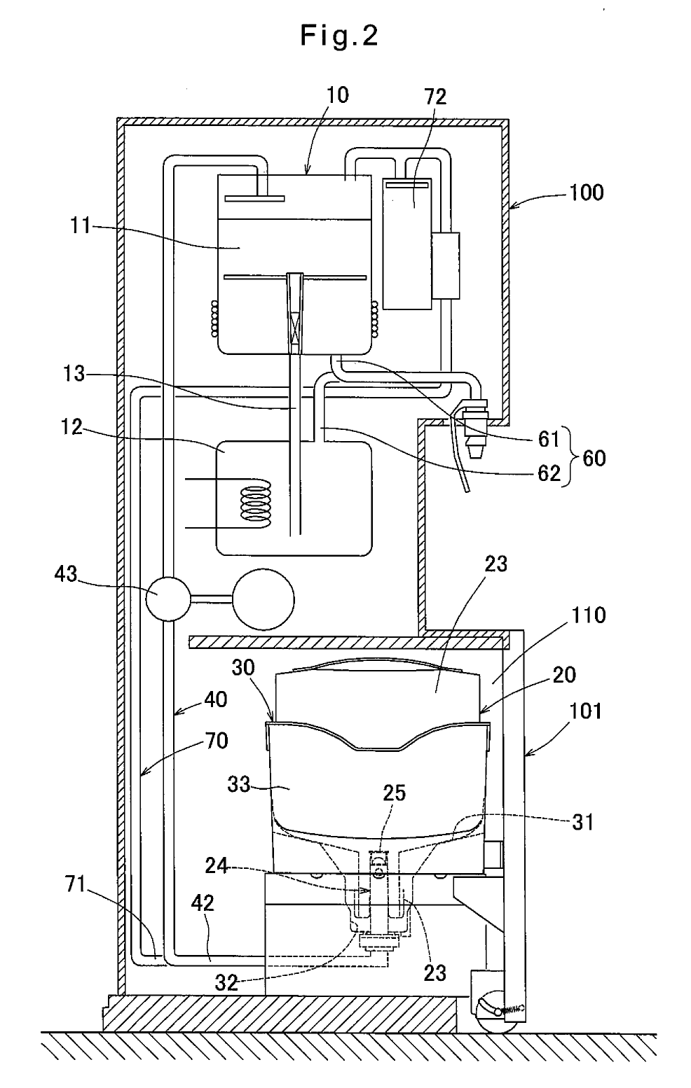

A water dispenser embodying the present invention is now described with reference to the drawings. As shown in FIG. 2, this water dispenser includes temporary water storage tanks 10, a container holder 30 in which a replaceable raw water container 20 is placed, and a water supply line 40 through which raw water is supplied from the raw water container 20 to the temporary water storage tanks 10, a pierced rod 50 formed with a raw water intake port 41 of the water supply line 40, water discharge lines 60 through which water in the temporary water storage tanks 10 is discharged to the outside, and air intake line 70 through which the interior of the raw water container 20 communicates with the atmosphere. These elements are all disposed in a casing 100.

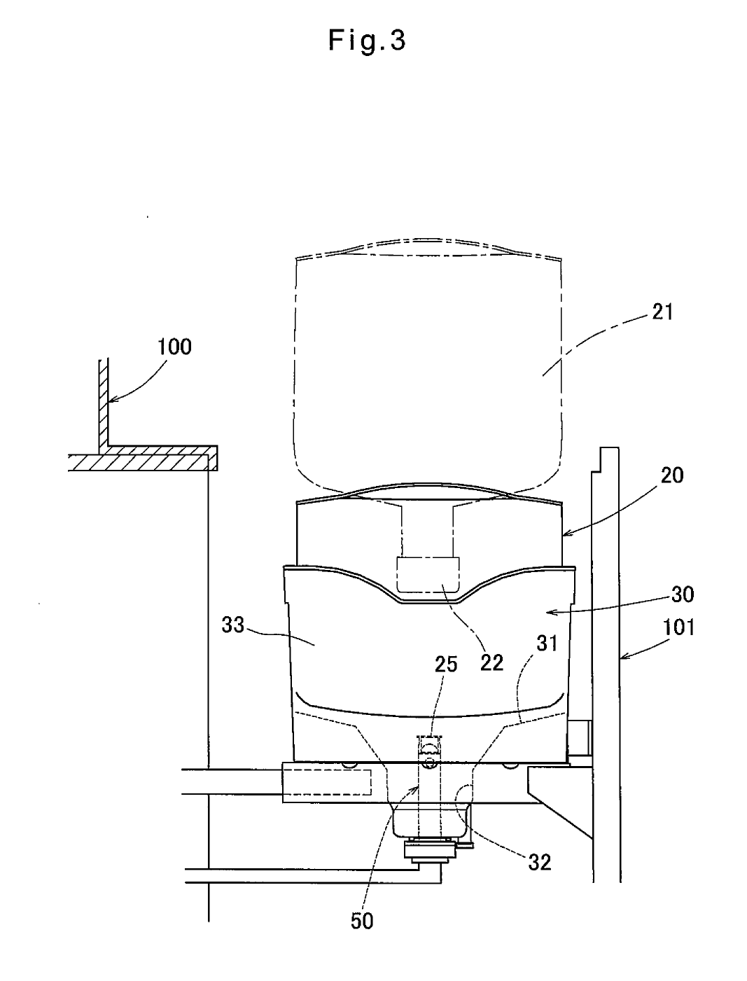

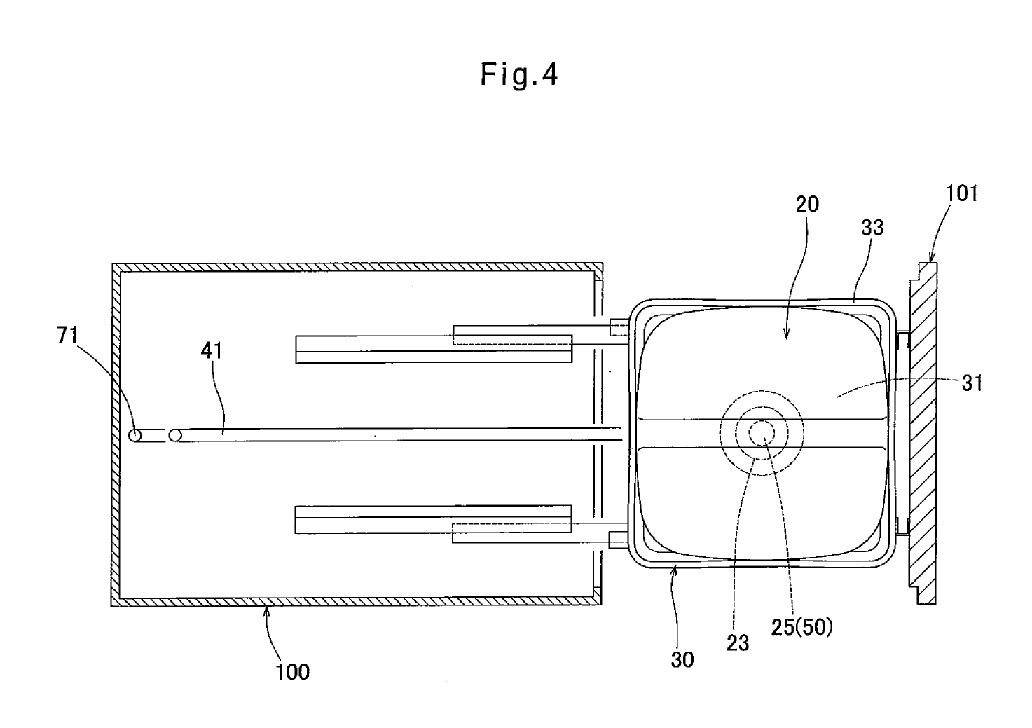

The casing 100 is a machine casing having a bottom portion placed on a horizontal surface. As shown in FIGS. 2 and 3, the casing 100 includes a slide table 101 which can be pulled forward out of a loading space located below the temporary water storage tanks 10. As shown in FIGS. 3 and 4, the slide table 101 is slidable in a horizontal direction in a straight line along guide rails laid on a bottom plate of the casing 100. The directions in which the slide table is slid into and out of the loading space correspond to the backward and forward directions of the water dispenser, respectively. The container holder 30 and the pierced rod 50 are provided on the slide table 101.

As shown in FIG. 2, the temporary water storage tanks 10 comprise tanks each provided with means for adjusting the temperature of water stored in the corresponding tank. In particular, the temporary water storage tanks 10 comprise a cold water tank 11 provided with a heat exchanger for cooling water stored in the cold water tank 11, and a hot water tank 12 provided with a heater for heating water stored in the hot water tank 12. The water dispenser further includes a water transfer line 13, of which the inlet is formed in a baffle plate configured to interfere with the downward flow of raw water fed from the water supply line 40. With this arrangement, water stored in the upper portion of the cold water tank 11 can flow into the hot water tank 12 through the water transfer line 13. One of the cold water tank and the hot water tank may be omitted.

The water discharge lines 60, as the outlet lines of the temporary water storage tanks 10, comprise a cold water discharge line 61 connected to the cold water tank 11, and a hot water discharge line 62 connected to the hot water tank 12, independently of the cold water discharge line 61. Valves are provided at the respective boundaries between the cold water tank and the cold water discharge line 61 and between the hot water tank and the hot water discharge line 62 such that when a user opens either one of the valves, water stored in the lower portion of the cold water tank 11 or water in the upper portion of the hot water tank 12 flows through the cold water discharge line or the hot water discharge line, and can be discharged into e.g. a cup.

As shown in FIG. 3, the raw water container 2 includes a container body 21 having a neck portion and a shoulder portion, and a plug 22 sealing the neck portion of the container body 21. The container body 21 is a variable-volume transparent member configured such that its peripheral wall portion located higher than the shoulder portion is spontaneously collapsible when the water remaining in the container body 21 decreases. Raw water is introduced into the container body 21 through its mouth defined by the inner periphery of the neck portion until the container is filled with water, and kept in the container by fitting the plug 22 onto the neck portion. With the container body 21 set upside down (its bottom at the highest level), the shoulder of the container body 21 is supported by the container holder 30 from below, until the raw water container 20 becomes practically empty. The shoulder portion of the container body 21 is inclined such that raw water collects into the neck portion. In order to minimize the amount of water remaining in the neck portion of the container body 21 and to allow the plug 22 to be pressed vertically onto the neck portion, the neck portion is a tubular member protruding from the shoulder portion and having a vertical axis, with the inner and outer diameters thereof not larger than the minimum inner and outer diameters of the shoulder portion.

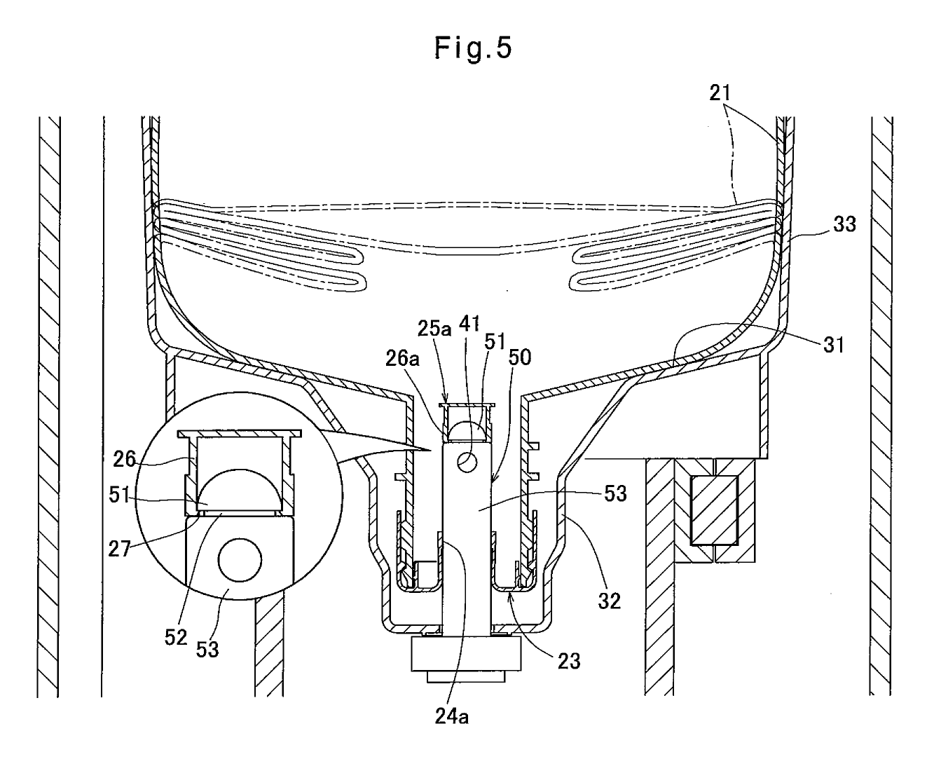

As shown in FIGS. 4 and 5, the container holder 30 includes a seating surface forming portion 31 for receiving the shoulder portion of the container body 21 from below, a cup portion 32 recessed from the seating surface forming portion 31, and an enclosure portion 33 integrally connected to the outer edge of the seating surface forming portion 31. The seating surface forming portion 31 supports the weight of raw water container 20 from below. The cup portion 32 is recessed downward from the seating surface forming portion 31 to such a depth and within such a horizontal positional range that the neck portion of the container body 21 can be inserted into the cup portion 32 from above. The cup portion 32 is configured such that water leaking out of the raw water container 20 is received in the cup portion 32. The enclosure portion 33 is configured to downwardly guide the peripheral wall portion of the container body 21 when the container body 21 is collapsed spontaneously. By pulling the slide table 101 forward, the container holder 30 and everything placed on the holder 30 can be pulled out of the casing 100. If a raw water container is used which is rigid enough not to be collapsible spontaneously, the enclosure portion 33 is not necessary.

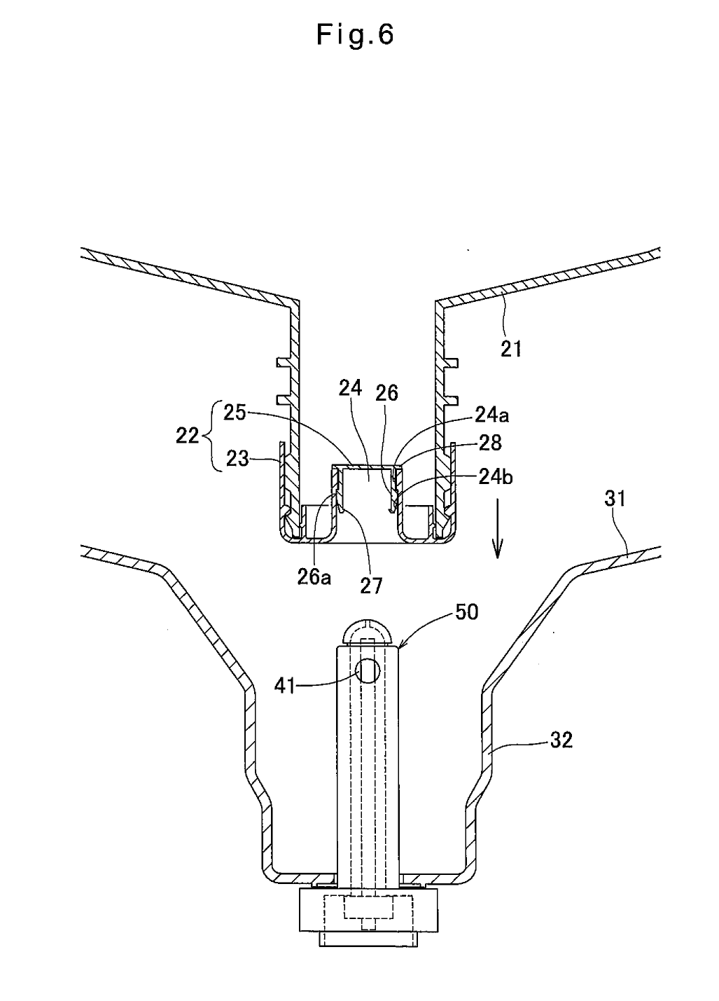

As shown in FIGS. 3 and 6, the plug 22 includes a plug body 23 fixed to the neck portion of the container body 21, and a valve body 25 configured to close a valve hole 24 formed in the plug body 23. The inner periphery of the valve hole 24 and the outer periphery of the valve body 25 have circular horizontal cross-sections. The valve hole 24 and the valve body 25 have a common vertically extending center axis. (The direction of this center axis is hereinafter referred to as the “axial direction” and every direction perpendicular to the center axis is referred to as a “radial direction”.) The valve body 25 includes a peripheral wall portion 26 which can be press-fitted into the inner periphery of the valve hole 24 in the axial direction, and a claw portion 27 provided over the entire circumference of the peripheral wall portion 26 to extend in the radial direction. The inner periphery of the valve hole 24 is stepped to form a small-diameter inner peripheral portion 24a having a smaller inner diameter than the remaining portion of the inner periphery of the valve hole 24. The outer periphery of the peripheral wall portion 26 is stepped to form a large-diameter outer peripheral portion 26a having a larger outer diameter than the remaining portion of the outer periphery of the peripheral wall portion 26. The large-diameter outer peripheral portion 26a of the peripheral wall portion 26 is configured to get caught on the small-diameter inner peripheral portion 24a of the valve hole 24 in the axial direction, thereby preventing separation of the valve body 25 in the axial direction toward the interior of the container. The valve body 25 has a flange portion 28 having an outer diameter larger than the diameter of the inner periphery of the valve hole 24. The flange portion 28 is configured to get caught on the open edge of the valve hole 24 facing the interior of the container in the axial direction, thereby preventing separation of the valve body 25 in the axial direction toward the outside of the container. A gap having a wedge-shaped section and open to the outside of the container is defined between the outer peripheral portion 26a and the large-diameter inner peripheral portion 24b of the valve hole 24 having a larger inner diameter than the inner peripheral portion 24a. The outer periphery of the peripheral wall portion 26 is pressed against the inner periphery of the valve hole 24 at its portion between the wedge-shaped gap and the stepped portion. The wedge-shaped gap makes it easier for the outer peripheral portion 26a to be radially outwardly deformed at its portion close to the claw portion 27.

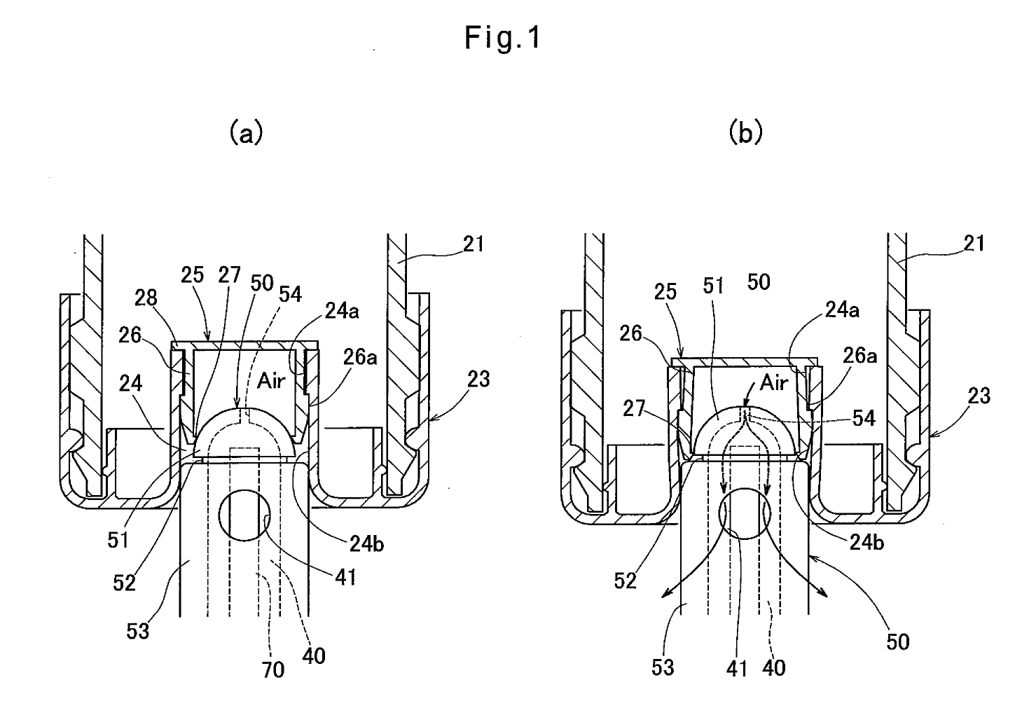

As shown in FIG. 4, when the pierced rod 50 is inserted in the cup portion 32, the pierced rod 50 extends vertically so as to be located, in plan view, at the common geometric center of the seating surface forming portion 31, which is annular in shape, and the enclosure portion 33. As shown in FIGS. 1(a) and 1(b), the pierced rod 50 includes a head 51 having a convex curved surface and capable of pushing the claw portion 27 uniformly over the entire circumference thereof, in the axial direction. The pierced rod 50 further includes a neck portion 52 having a smaller diameter than the base of the head 51 to define a circumferential groove in which the claw portion 27 is engageable, and a cylindrical trunk portion 53 extending from the neck portion 52 and having an outer diameter larger than the maximum inner diameter of the valve hole 24. The interior of the pierced rod 50 is divided into one end portion of the water supply line 40 and one end portion of the air intake line 70. The trunk portion 53 is formed with a raw water intake port 41 through which raw water in the container body 21 is introduced into the water supply line 40. The pierced rod 50 is further formed with an air hole (not shown) through which air in the air intake line 70 is introduced into the container body 21.

A through hole 54 is formed in the head 51 so as to communicate with the water supply line 40 in the pierced rod 50. The through hole 54 opens at the apex of the head 51.

As shown in FIG. 2, the water supply line 40 includes a connecting pipe 42 having one end thereof connected to the portion of the water supply line 40 in the pierced rod 50. Similarly, the air intake line 70 includes a connecting pipe 71 having one end thereof connected to the portion of the air intake line 70 in the pierced rod 50. The connecting pipes 42 and 71 are soft and flexible pipes that are deformable following the movement of the slide table 101 when the slide table 101 is pulled into and out of the housing. A pump 43 for drawing up water is provided at an intermediate portion of the water supply line 40. The air intake line 70 always communicates with the atmosphere through an air chamber 72 and with the interior of the container body 21 so that air can be introduced into the container body 21 through the air intake line 70. After the container body 21 has been collapsed until it cannot be collapsed any further, as the water remaining in the container body 21 decreases, air is sucked into the container body 21 through the portion of the air intake line 70 shown in FIGS. 1(a) and 1(b) to prevent negative pressure in the container body 21. The air chamber 72 is preferably provided with a filter for removing contaminants in the atmosphere, such as dust, odor and bacteria.

In order to connect a new raw water container 20 to the water supply line 40 of the water dispenser, as shown in FIGS. 3 and 6, while being positioned upside down, the raw water container 20 is lowered into the space surrounded by the enclosure portion 33. While the container is being lowered and before the shoulder portion of the container body 21 contacts the seating surface forming portion 31, the enclosure portion 33 guides the peripheral wall portion of the container body 21 so as to move the raw water container 20 to a position in the air where the pierced rod 50 can be inserted into the valve hole 24 in the axial direction. When the head 51 contacts the claw portion 27, as shown in FIG. 1(a), the trunk portion 53 is partially fitted to the large-diameter inner peripheral portion 24b of the valve hole 24, and the head 51 is inserted, to its axially intermediate portion, into the peripheral wall portion 26. When the raw water container 20 is further lowered, the pierced rod 50 is further deeply and axially inserted into the container 20 with the pierced rod 50 and the inner peripheral portion 24b axially moved and guided relative to each other. This causes the claw portion 27 to be pushed in the axial direction by the head 51 of the pierced rod 50 over the entire circumference of the claw portion 27. Due to a tapered engaging surface of the claw portion 27 and the convex curved surface of the head 51, when the claw portion 27 is pushed by the head 51 in the axial direction, the claw portion 27 is also pushed radially outwardly. This causes elastic deformation of the claw portion 27 such that its portion near the edge of the tapered engaging surface is slightly deflected in the axial direction, and also causes, as shown in FIG. 1(b), elastic deformation of the tubular protruding wall of the plug body 23 having the inner periphery defining the valve hole 24 such that the tubular protruding wall is radially outwardly inclined to such an extent that the outer peripheral portion 26a of the peripheral wall portion 26 remains caught on the small-diameter inner peripheral portion 24a of the valve hole 24. Due to these elastic deformations, the head 51 can slip past the claw portion 27. When the head 51 clears the claw portion 27, the claw portion 27 is engaged in the neck portion 52 due to its elastic recovery, thus getting caught on the head 51 in the axial direction over the entire circumference of thereof, as shown in the circle of FIG. 5. In this state, the claw portion 27 securely tightens the head 51 in the radial direction over the entire circumference of the head 51.

After the claw portion 27 gets caught on the head 51 and before the shoulder portion of the container body 21 is seated on the seating surface forming portion 31 as shown in FIG. 5, the peripheral wall portion 26 is continuously pressed by the shoulder of the trunk portion 53 in the axial direction. Since the stepped surfaces where the inner peripheral portion 24a and the outer peripheral portion 26a are caught on each other are slightly inclined, when the peripheral wall portion 26 is pressed by the shoulder of the trunk portion 53 in the axial direction, the inner peripheral portion 24a is also pushed radially outwardly by the outer peripheral portion 26a, whereby the outer peripheral portion 26a disengages from the inner peripheral portion. Then, with the inner peripheral portion 24a kept in close contact with the trunk portion 53 instead of with the outer peripheral portion 26a, the shoulder of the trunk portion 53 keeps pressing the valve body 25 in the axial direction, thereby disconnecting the valve body 25 from the plug body 23, until the raw water intake port 41 is moved into the container body 21.

It is considered that the raw water container 20 has become practically empty when the water level in the container body 21 decreases to a level lower than the raw water intake port 41. That is, when the raw water container 20 becomes practically empty, a small amount of water still remains in the container. When the practically empty raw water container 20 is raised, and the pierced rod 50 is pulled out of the plug body 23, since the claw portion 27 remains caught on the head 51, the peripheral wall portion 26 of the valve body 25 is fitted, taking the place of the trunk portion 53, into the inner peripheral portion 24a while radially expanding the inner peripheral portion 24a with the outer peripheral portion 26a . When the container is further raised after the flange portion 28 has axially engaged the open edge of the valve hole 24 facing the interior of the container, the valve body 25 is disconnected from the pierced rod 50 as shown in FIG. 6. Thus, when the pierced rod 50 is pulled out of the plug body 23, the valve hole 24 is spontaneously closed by the valve body 25, so that it is possible to automatically prevent leakage of water remaining in the raw water container 20 simply by raising the container.

As described above, the water level in the water supply line 40 is below the raw water intake port 41 before a new raw water container 20 is connected to the water supply line 40, so that the raw water intake port 41, which is formed in the trunk portion 53, is located outside of the raw water container 20 and communicates with the ambient atmosphere while the head 51 is sliding on the claw portion 27. During this period, since atmospheric air in the space defined by the peripheral wall portion 26 can hardly be released into the atmosphere through a gap between the claw portion 27 and the head 51, atmospheric air in the space defined by the peripheral wall portion 26 is released through the through hole 54 into the portion of the water supply line 40 disposed in the pierced rod 50, thus expelling atmospheric air in the water supply line 40 into the atmosphere through the raw water intake port 41, as shown by the arrows in FIG. 1(b). Thus, in this water dispenser, when a new raw water container 20 is connected to the water supply line 40, more specifically, when the head 51 is pushing the claw portion 27, the head 51 can be pushed in while allowing atmospheric air in the space defined by the peripheral wall portion 26 to be released into the pierced rod 50 through the through hole 54, and thus without substantially compressing atmospheric air in the space defined by the peripheral wall portion 26. This makes it easier to hook the claw portion 27 on the head 51.

In order to allow atmospheric air in the space defined by the peripheral wall portion 26 to be released into the pierced rod 50, the through hole 54 may be open not at the apex, i.e. the distal end, of the head 51, but at any portion of its surface closer to the distal end of the head 51 than is the portion of the head 51 which contacts and pushes the claw portion 27 in the axial direction, namely, at any portion of its surface located at a higher level, in FIG. 1(a), than the contact portion between the head 51 and the claw portion 27. The present invention is not limited to the above-described embodiment but encompasses every modification thereof which is within the scope of the claims. For example, the present invention encompasses an arrangement in which the pierced rod is movable as in Patent document 2, and a water dispenser in which the raw water container is placed on a container holder fixed in position at the upper portion of the housing so that water is supplied through the water supply line under gravity, as disclosed in Patent document 1.

### DESCRIPTION OF THE NUMERALS

10. Temporary water storage tank

20. Raw water container

21. Container body

22. Plug

23. Plug body

24. Valve hole

25. Valve body

26. Peripheral wall portion

27. Claw portion

30. Container holder

40. Water supply line

41. Raw water intake port

50. Pierced rod

51. Head

54. Through hole

100. Casing

1. A water dispenser comprising a casing, a temporary water storage tank provided in the casing, a container holder provided in the casing and on which a replaceable raw water container can be placed, a water supply line provided in the casing and through which raw water can be supplied from the raw water container into the temporary water storage tank, and a pierced rod provided in the casing and formed with a raw water intake port through which raw water can be fed into the raw water supply line,
wherein the raw water container comprises a container body and a plug, the plug comprising a plug body fixed to the container body and formed with a valve hole, and a valve body capable of closing the valve hole,
wherein the valve body includes a peripheral wall portion configured to be press-fitted into an inner periphery of the valve hole, and a claw portion protruding from the peripheral wall portion over an entire circumference of the peripheral wall portion,
wherein the pierced rod has a head,
wherein the water dispenser is configured: such that when the head is pushed into the plug body, the head pushes the claw portion of the valve body over an entire circumference of the claw portion until the claw portion gets caught on the head over the entire circumference of the claw portion, and thereafter, the pierced rod is brought into close contact with the inner periphery of the valve hole while pushing the valve body out of the valve hole until the valve body is separated from the plug body; and such that when the pierced rod is pulled out of the plug body, the peripheral wall portion is fitted into the inner periphery of the valve hole while the pierced rod is pulled out of the valve hole until the valve body gets caught on the plug body, and thereafter, the valve body is separated from the pierced rod, and
wherein a through hole is formed in a portion of the head closer to a distal end of the head than is a portion of the head configured to contact and push the claw portion such that atmospheric air in a space defined by the peripheral wall portion is released into the pierced rod through the through hole.
